(19) United States
(12) Patent Application Publication
(10) Pub. No.: US 2014/0278528 A1
(43) Pub. Date: Sep. 18, 2014

(54) APPARATUS AND METHOD FOR A DIGITAL MEDICAL ASSISTANT

(71) Applicants: Vikram Simha, Boston, MA (US); Gang Li, Acton, MA (US); Steven H. Sandy, Foster City, CA (US)

(72) Inventors: Vikram Simha, Boston, MA (US); Gang Li, Acton, MA (US); Steven H. Sandy, Foster City, CA (US)

(21) Appl. No.: 13/827,238

(22) Filed: Mar. 14, 2013

(51) Int. Cl. G06F 19/00

(52) U.S. Cl. CPC G06F 19/328
USPC 705/3

(57) ABSTRACT

A digital medical assistant is configured to obtain authorization of a service request. The assistant includes: an input for receiving an electronic medical record (EMR) of a patient and identity of a benefit provider for the patient; a preauthorization engine configured for completing an application by identifying relevant clinical context from the EMR and correlating the relevant clinical context with preauthorization criteria; the preauthorization engine further configured for submitting a completed application as the request to the benefit provider, receiving a decision from the provider, and outputting the decision. A method of use in a computer program product are provided.

### BACKGROUND OF THE INVENTION

1. Field of the Invention

The invention disclosed herein relates to electronic medical record (EMR) systems, and, in particular to systems for integration of clinical data, patient diagnosis, and management of approvals for medical services.

2. Description of the Related Art

Patient information consists of various types of clinical data, both textual (blood tests, labs, office notes, prior reports, etc.) and images (X-Ray, CT, MR, Ultrasound, etc.). Clinical data are stored on one or more electronic medical record systems (inpatient EMR, outpatient EMR, specialty EMR, office note systems, lab information systems, etc.) and image data are stored on different departmental imaging systems (Radiology RIS/PACS, Cardiology PACS, Oncology PACS, Advanced Visualization systems, Computer Aided Detection systems, Cardio-vascular Information systems (CVIS), etc.). These disparate systems do not communicate or integrate well with each other. This problem is further exacerbated by the fact that these systems are very often location and specialty specific.

In the days of paper-based records, a medical assistant collected, sorted and organized the patient's medical records based on the physician's specialty and the patient's clinical status and provided the most relevant clinical context for the physician or medical practitioner in a paper jacket. Moving to EMRs has made all patient information available digitally. However, patient information now resides on multiple disparate systems and the burden of gathering, collecting, sorting and filtering the relevant clinical context has shifted to the physician. This shift and the fact that the current EMR's are more about content and less about context causes the physician to spend more time searching digital systems for patient's information, thus reducing the time spent with patients, making the physician less productive. In many cases physicians have difficulty finding the relevant contextual information they seek resulting in ordering duplicate/unnecessary tests/scans and/or requiring some duplication of effort.

As a result of the propagation of disparate and proprietary health information and imaging systems, and the enormity of patient information collected, delivering healthcare services has become prohibitively expensive, inefficient, and compartmentalized, with the delivery and quality of patient care inconsistent from department to department, hospital to hospital, with large variations in patient outcomes.

Consider, for example the process involved with a primary care physician (PCP) providing a referral to a specialist. Presently, the primary care physician (PCP) begins by examining the patient. The PCP will complete a workup of relevant symptoms which may indicate a need for more in-depth examination by a specialist. These indications and symptoms are identified to a health benefits company (payer) via a request for authorization for the referral, while the patient simultaneously schedules an appointment with a specialist. The payer will review the request for authorization from the PCP and then approve or deny the request. The patient, in need of specialized services, may or may not have a requests that is authorized by the payer at the time of the appointment with the specialist. If the request for the patient was not authorized by the payer, then the specialist will typically prepare and resubmit another request for approval. Generally, communications are limited to various forms of mail or by use of fax machines. Accordingly, this is a time-consuming process that includes a number of delays and handling by different people and therefore may include substantial opportunities for human error. Aspects of this process are highlighted in FIG. 1.

What are needed are effective systems for collecting and presenting clinical data. The systems should be equipped to assimilate data from a diverse set of resources. Further, the systems should provide for effective communication with third parties such as to provide for real-time communication and evaluation by insurance providers.

### SUMMARY OF THE INVENTION

In one embodiment, a digital medical assistant is configured to obtain authorization of a service request. The assistant includes: an input for receiving an electronic medical record (EMR) of a patient and identity of a benefit provider for the patient; a preauthorization engine configured for completing an application by identifying relevant clinical context from the EMR and correlating the relevant clinical context with preauthorization criteria; the preauthorization engine further configured for submitting a completed application as the request to the benefit provider, receiving a decision from the provider, and outputting the decision.

In another embodiment, a method for obtaining authorization for a service request for a patient is provided. The method includes: electronically initiating the service request by selecting a procedure; identifying relevant clinical context from an electronic medical record (EMR) of the patient and correlating the relevant clinical context with preauthorization criteria; submitting a completed application as the request to the benefit provider, receiving a decision from the provider, and outputting the decision.

In another embodiment, a computer program product stored on machine readable media, the product includes instructions for implementing a method for obtaining authorization for fulfillment of a service request, by: electronically initiating the service request by selecting a procedure; identifying relevant clinical context from an electronic medical record (EMR) of the patient and correlating the relevant clinical context with preauthorization criteria; submitting a completed application as the request to the benefit provider, receiving a decision from the provider, and outputting the decision.

### BRIEF DESCRIPTION OF THE DRAWINGS

The features and advantages of the invention are apparent from the following description taken in conjunction with the accompanying drawings in which:

FIG. 1 is a graphic that depicts current day processes for attaining third-party approval for medical service referrals;

FIG. 2 is a graphic the provides a high level architecture for a digital medical assistant (DMA) as disclosed herein;

FIG. 3 is a graphic that depicts steps in competitive techniques for diagnosing ankylosing spondylitis (AS);

FIG. 4 presents a case study of four patients exhibiting similar symptoms. In this example, imaging exam results are the same, but a differential diagnosis depends on patient's history and clinical status;

FIGS. 5-11 depict additional aspects and additional embodiments of the DMA;

FIG. 12 is a graphic the provides an overview of process interfaces for providing patient referrals;

FIGS. 13-24 are graphics depicting exemplary user interface screens displayed during a process of patient referral.

### DETAILED DESCRIPTION OF THE INVENTION

Disclosed herein is a “Digital Medical Assistant (DMA).” The DMA provides a diverse array of capabilities for improving efficient delivery of healthcare services. In general, the DMA may receive a variety of inputs and collect a variety of forms of data. The DMA is generally configured to receive the inputs and data and apply complex rules and constraints to provide for efficient management of healthcare services. In particular, in various embodiments, the DMA is configured to provide for efficient patient referral and prior authorization, comprehensive management of clinical information, and financial administration.

As an overview of patient referral, consider the following. First, note that there is a great diversity of benefit providers (each of which is generically referred to herein as a “payer”). Patient referral begins when an individual comes to see a physician (or any other appropriate medical professional). The individual (i.e., the patient) is examined by the physician, and the physician uses professional judgment in determining that the individual may be in need of specialized services (e.g., examination by a specialist). That is, it is the judgment of the examining physician that there is a “medical necessity” for referral. However, where third parties, such as insurance companies and other benefit providers have a role in the decision-making process, it is not the judgment of the physician alone that can authorize a referral.

Advantageously, the DMA provides for rapid completion of the decision-making process. Generally, the digital medical assistant (DMA) is configured with payer criteria or rapid access to payer criteria. The payer criteria include rules and guidelines established by the various health benefit providers for pre-authorization of services. Accordingly, by using the DMA, the referral process can rapidly compare symptoms exhibited by the patient against the payer criteria. Thus, the DMA provides for rapid evaluation of third-party benefits that are available to the patient and provides for issuing a decision. Further, where appropriate use guidelines exist, the DMA can rapidly compare symptoms exhibited by the patient against the appropriate use guidelines. Accordingly, the DMA provides for rapid comparison and evaluation by parties and the referral process, as well as communication of clinical context to parties involved.

In order to provide some context, some non-limiting aspects of terms that may be used herein are provided.

As discussed herein, the term “Accountable Care Organizations (ACOs)” generally refers to provider-led organizations whose mission is to align incentives and accountability across the continuum of care based on quality metrics and reductions in the total cost of care for an assigned population of patients. ACO's are driving adoption of pay-for-performance reimbursements vs. fee-for-service.

As discussed herein, the term “Affordable Care Act (ACA)” generally refers to legislation passed in 2010. The ACA provides a number of incentives, including subsidies, tax credits, fees to employers and individuals in order to increase the coverage rate. Additional reforms are aimed at improving healthcare outcomes and streamlining delivery of healthcare.

As discussed herein, the term “Appropriate Use Guidelines” generally refers to evidence-based clinical guidelines that span the continuum of care, including chronic care and behavioral health management. Providing much more than authorization criteria, appropriate use guidelines drive high-quality care through such tools as pathway tables, flagged quality measures, and integrated medical evidence. “Appropriate Use Guidelines” may also be referred to herein as “Appropriate Use Criteria.” Generally, appropriate use guidelines are promulgated by third parties that are not involved in the care of the patient. For example, appropriate use guidelines may be promulgated by industry organizations, such as the American Medical Association (AMA) and the like. Appropriate use guidelines may consider a number of aspects of the relevant clinical context that are not particular to a clinical evaluation of the patient. For example, the appropriate use guidelines may consider family history, demographics, and other such information.

As discussed herein, the term “Clinical Content” generally refers to a total amount of patient information available, no matter where it is stored.

As discussed herein, the term “Relevant Clinical Context” generally refers to most relevant clinical information required by a physician or other medical professional to help make a differential diagnosis, decide on a treatment plan or to otherwise proceed on behalf of the patient. Note that clinical context may differ between professionals. For example, only certain matters related to a patient may be relevant to a particular provider. More specifically, what is relevant regarding a patient may differ based on consideration of diagnosis, referral, or financial matters.

As discussed herein, the term “Electronic Medical Record (EMR)” generally refers to electronic forms of patient information. Generally, electronic forms of patient information may come from a variety of sources including directly from equipment (such as a scanner), indirectly from equipment (such as by importing lab results and the like) and from other sources such as manual input of notes (such as by typing into the system, or loading documents for optical character recognition). Accordingly, the system disclosed herein may, among other things, assist with generation of the EMR.

As discussed herein, the term “Evidence-Based Medicine (EBM)” generally refers to a philosophy to apply the best available knowledge-based evidence gained from the scientific method to clinical decision making.

As discussed herein, the term “ICD-10 Codes” generally refers to codes that will be required for classifying medical services by Medicare starting October 2014. Currently doctors use the ICD-9 code standard, which contains far fewer individual codes but permits less specificity when making diagnoses. ICD-10 codes, ICD-9 codes and any other classification codes as may be relevant to a user or system operator are generally referred to herein simply as “codes,” “classification codes,” and by other similar terms. Generally, these and other coding schemes provide for classification of medical condition according to diagnostic information.

As discussed herein, the term “Independent Physician Associations (IPAs)” generally refers to associations that offer coordinated care systems and case management systems that the small practice will never be able to build, and personnel to link the communications and systems between the patient and doctor.

As discussed herein, the term “Integrated Delivery Networks (IDN)” generally refers to a network of facilities and providers that work together to offer a continuum of care to a specific geographic area or market. IDNs include many types of associations across the continuum of care.

As discussed herein, the term “Meaningful Use” generally refers to rules and regulations that hospitals and physicians must meet to qualify for federal incentive funding. This includes using an Electronic Health Record for functions that both improve and demonstrate the quality of care, such as e-prescribing, electronic exchange of health information, and submission of quality measures to CMS.

As discussed herein, the term “payer criteria” generally refers to rules, guidelines and policies of a health benefit provider with respect to distribution of healthcare services. Generally, payer criteria may be condition specific (such as for a given disease) and may further consider prevailing standards of practice, expert opinions, availability of technology, and evidence-based criteria.

As discussed herein, the term “Preauthorization” generally refers to an approval process that is required before a test or procedure is performed to ensure that the procedure will be covered by the insurer. In the prior art, a practitioner who expected to be paid for a service must have used paperwork and telephone contact with a designated entity, often a third-party administrator to determine whether the proposed treatment or procedure was deemed “medically necessary.” It should be noted that the system and teachings herein are not limited to pre-authorization. More specifically, and by way of example, the system may be used to obtain authorization after or during the fulfillment of a service request. Accordingly, the “pre-authorization engine” described herein may be used for authorization, regardless of timing of delivery of services.

As discussed herein, the term “Primary Care Practices” generally referred to small to mid-sized family practice or independent physician practices.

Generally, the digital medical assistant (DMA) is an enterprise system that may be equipped to interface with a variety of other systems and personnel. For example, the DMA may interface with a variety of diagnostic and/or therapeutic equipment (such as scanners, monitors, lab equipment and the like, broadly referred to herein as “clinical equipment”) as well as information technology equipment (such as patient databases, remote databases, knowledge bases, and third-party systems). In some embodiments, the DMA includes remote software and processing that may be operated through, for example, a browser. Through these various resources, as well as other dedicated access paths, personnel are equipped to interface, interact with and control the DMA.

The DMA may include dedicated or shared equipment as is known in the art. For example, the DMA may be provided with a plurality of workstations (including traditional components such as a personal computer, a keyboard, a video display, and mouse), at least one server, a plurality of processors, a variety of data storage facilities (such as hard drives, tape, optical drives, magnetic optical drives, volatile and/or nonvolatile memory, and the like). The DMA may also include a variety of interface capabilities such as Ethernet, 802.11 protocols, fiber connections and the like. The DMA may be provided with application-specific components such as barcode readers, smartcard readers (including a population of smart cards), radio frequency identification (RFID) devices, biometric recognition devices (such as fingerprint scanners, retinal scanners, and the like). Further, the DMA may include software packages as appropriate to enhance or enable operation of the DMA. For example, the DMA may host (and therefore include) an image viewer, a practice management application, a transcription application, etc. The DMA may support HL 7, EDI, DICOM servers, Web servers and the like. Accordingly, the DMA may be provided as a combination of hardware and software (that is, as machine executable instructions stored on machine readable media), and may at least borrow from or share resources of other systems.

In some embodiments, servers are provided as a software-only stack based on a Python and Django web framework to help rapid development and customization. This can be fully virtualized or hosted via a remote service provider, commonly referred to as in a “cloud.”

In some embodiments, the client side is a zero install, zero footprint system that is based on web technologies like HTML5, Javascript, AJAX, etc. In these embodiments, the DMA may be configured to operate in any web browser on any computer, tablets (like iPADs), or smartphone and any type of mobile devices that are deemed appropriate. The DMA may include output to a printer. A smart dashboard may be included to display relevant clinical context aggregated from multiple sources (inpatient EMR, outpatient EMR, office notes system, lab systems, etc.). In some embodiments, the only input needed to mine data is user login credentials and identity of the patient being examined. In these embodiments, this information may be obtained through an integration API and/or the CCOW IHE integration profile, and/or assembled internally within the DMA 100 by, for example, retrieving information from within the DMA 100, or other systems in communication with the DMA 100.

Referring now to FIG. 2, there is shown a high level architecture for the digital medical assistant (DMA) 100. In this exemplary overview, the DMA 100 receives patient data 2 from a variety of sources. The sources may include any type of data producing equipment used in the medical setting (as introduced above). Generally, the DMA 100 is highly configurable and accommodates a wide variety of users. Accordingly, user and role preferences 4 may be tracked and input into the DMA 100. By maintaining user and role preferences 4, the DMA 100 offers users highly efficient and specialized services as appropriate. In addition, the DMA 100 may be configured to make use of a wide variety of payer or appropriate use criteria 6. The payer criteria or appropriate use criteria 6 may be deployed for ensuring services provided meet a prevailing standard of care. Accordingly, the DMA 100 may be configured to communicate with external sources such that payer criteria or appropriate use criteria 6 (and other aspects as appropriate) are maintained up to date.

Generally, the DMA 100 will manage the abundance of input information and provide relevant clinical context for each patient. This includes efficient patient referral, efficient management of relevant clinical information and financial reconciliation.

Consider the following introductory aspects of the DMA 100.

The DMA may be configured such that user login credentials are associated with and provide needed information about the physician's role and location (outpatient clinic or hospital inpatient location). API integration for third party systems may be configured to provide identity of the patient name, medical record number (MRN), and/or patient ID, and other details that may be considered relevant for uniquely identifying the patient at that specific hospital or IDN. Using these or similar pieces of data, the DMA 100 is able to aggregate (via, for example, HL-7, DICOM or integration API's) the patient information from the various systems for that particular patient. A “smart dashboard” may be provided to prioritize and overlay relevant clinical context on top of the EMR and/or imaging system information with which the user is interacting.

A query process engine may be used to preprocess data and query the data based on a role of the physician and a clinical status of the patient. In general, “pre-processing” refers to anything that the DMA 100 may do to better refine or better qualify patient data (e.g. run Natural Language Processing on prior radiology reports to better qualify a potential diagnosis, or look at the latest blood tests ordered to qualify potential clinical conditions, etc.). As an example, if a test for Rheumatoid Factor has been ordered, then the physician is likely seeking to diagnose some form of arthritis. If an HbAlC test and a lipid profile was ordered, and has been repeated at regular intervals, then the patient is likely being seen for diabetes follow-up.

Retrieved information will contain information about related factors for medical conditions and/or patient's symptoms under consideration. The medical practitioner can query patient data using one of several options, such as by requesting patient data based on a particular clinical condition, or based on the latest tests/reports that have been performed, or all of the patient data, or patient data limited to a certain period of time, etc.

Two additional examples of operation of the DMA 100 are provided. In the first example, a physician is presented with the patient exhibiting symptoms of arthritis. Ankylosing Spondylitis (AS) is form of arthritis that primarily affects the spine, although other joints can be involved. It is important for the physician to differentiate AS from other forms of arthritis, like Rheumatoid Arthritis (RA), as the treatment for the two conditions is different. To make the differential diagnosis, and internist or specialist needs to review radiology reports, X-rays, prior office notes, and two blood tests. FIG. 3 shows a savings in a number of steps (clicks) and hence time savings that can be achieved when diagnosing a case of Ankylosing Spondylitis (AS) by using the DMA 100 over a prior art solution.

In a second example, a physician is presented with four different patients that exhibit chest pain. Radiology X-ray findings are identical for all four patients, and show a 5 mm left upper lobe density on a chest X-ray, widening mediastinum and deformity of the fifth rib, but the differential diagnosis and treatment plan is different based on the patient's prior history and clinical status. Reference may be had to FIG. 4, where differential diagnoses result from the consideration of additional clinical content.

In some embodiments, the DMA 100 may offer data mining services to third parties. Data mining services may be useful for example, for applications like cross-patient disease studies, physician billing patterns, automated patient flow, quality measures, readmission rates, more detailed data calculations, analysis, and other medical activities. For example, the DMA might show a list of all patients that have been diagnosed with hypertension that have high cholesterol levels, or all patients that have diabetes that also have high blood pressure, and the like.

In another embodiment, the DMA may be configured to automatically obtain information and perform background evaluations of exhibited symptoms. For example, the DMA may be configured to obtain data from chart notes provided by a physician, and to compare the chart notes and any additional patient data against payer criteria as well as appropriate use guidelines.

The DMA 100 may make use of data from any format including, for example, HL-7, DICOM, HTML, EDI HIPAA 5010, PNG, TIFF, JPG, XML, Word, scanned documents, etc. The data may be received through various data paths such as, for example, an HL7, EDI, DICOM or web services interface. Hospital information technology (IT) personnel may provide the inputs by connecting the proper feeds or enabling integration with the appropriate systems. Once the DMA 100 has been enabled to receive the healthcare provider data feed, data may be accessed on a continuing or ongoing basis.

Once data is received, it may be analyzed using various analysis engines. Exemplary analysis engines include access to template based searches, Natural Language Processing (NLP), Optical Character Recognition (OCR), and the like in order to obtain and present the data in context. An application programming interface (API) may be offered to third parties to help develop any additional analysis engines in addition to the engines already provided. As one example, a third-party may wish to develop a focused NLP algorithm to understand and mine Pathology reports, Oncology reports, or the like.

Generally, the DMA 100 is configured for extracting relevant patient data from scanned documents using Optical Character Recognition (OCR) technology to scan the document and parse out and tag information for context analysis. In some embodiments, the tags include relative location information for the scanned document. For example, a Radiology report saved to a database may include information to indicate where the section on interpretation or findings is located, the starting line in the scanned document, and column. This enables the DMA 100 to quickly present the document as well as the relevant information within the document. By analyzing the documents as they are received, important sections of each document may be marked. Commonly, radiology reports have an interpretation that is included in a “findings” section. This information is generally important for a practitioner. Accordingly, the DMA 100 may include a simple template-based search for the words “interpretation,” “findings,” or the like, and will identify an appropriate part of the radiology report to highlight.

The DMA 100 may provide a hierarchical user preference and customization system. User preferences may be set up by institution, department, group, country-state, or individual user. A variety of techniques are known for setting user preference information as well as system customization. Generally, the DMA 100 is configured to make use of any appropriate preference and customization setting tools deemed appropriate.

Generally, the DMA 100 is configured to track information according a prevailing standard of care for indicated conditions or symptoms as well as according to the preferences or needs of a particular user (such as an institution, department group, physician or other medical professional). Generally, standard of care information may obtained by interfacing with third party software, for example, via an integration API. Companies that provide standard of care information include “UpToDate.com,” “First Consult,” and “DynaMed,” as well as others. Information that may be tracked may include any form of tests, reports, scan data, lab results, practitioner notes, data received from another provider, and the like. Additionally, a variety of professional organizations provide appropriate use criteria. For example, the American College of Cardiology (ACC), the American College of Radiology (ACR), the American Medical Association (AMA) and other similar organizations may provide appropriate use criteria. Benefits providers such as CMS, Aetna, United Healthcare, Blue Cross Blue Shield and other similar firms provide payer criteria.

Generally, the relevant clinical context is provided as output in a standard computer usable format such as JSON/XML/HTML5. This not only drives the display of a “smart dashboard” but may also be used by third parties through a web services interface to drive a more informed workflow downstream, like better image segmentation, focused radiology reporting, and the like.

Additional aspects of exemplary embodiments of the DMA 100 are shown in FIGS. 5-11. FIG. 5 is a block diagram representation of exemplary workflow for a physician for clinical conditions that require imaging services. FIG. 6 is a clinical conditions flow chart depicting where the DMA 100 fits relative to the user after data aggregation from EMRs and imaging systems. FIG. 7 is a block diagram depicting use of the DMA 100 for clinical conditions that call for imaging services. FIG. 8 is a block diagram depicting use of the DMA 100 for general clinical conditions that do not call for imaging services. FIG. 9 depicts an embodiment of different functional architectural layers that make up the DMA 100. FIG. 10 is a block diagram depicting various architectural software layers including web services stack, API engines, and third party integration layer. FIG. 11 is an exemplary screenshot of a portion of the smart dashboard.

Having introduced aspects of the digital medical assistant (DMA) 100, methods and apparatus configured for facilitating third-party services, such as referral to specialist providers, and now introduced in more detail.

Referring now to FIG. 12, there is shown a graphic that provides an overview of communications and data interfaces involved in patient referrals. In this embodiment, the digital medical assistant (DMA) 100 provides for real-time or near real-time authorization of referrals to third parties. In this example, the third party is a specialist.

To get underway, the primary care physician (PCP) will access the digital medical assistant (DMA 100) through a workstation, such as a personal computer that is in communication with the DMA 100. Once the PCP has logged into the DMA 100 as a user, the DMA will recognize all user preferences associated with the account of the PCP and configure appropriate aspects of the DMA 100 accordingly. For example, once the PCP has logged in, the DMA 100 may present patient information for only those patients that see the PCP. Separately, and downstream, for example, in the case of the specialist, the specialist may log into the DMA 100 and only see certain aspects of patient information that relate to the given specialty. Of course, when a user logs in, the DMA 100 may also provide or limit accessibility to other components such as system data (such as billing information and the like), clinical equipment (such as scanning equipment and the like), as well as system components (such as printers and the like).

Once the PCP has logged into the system, the process begins with diagnosis of the patient. During diagnosis, the primary care physician (PCP) uses whatever tools are deemed appropriate and collects patient information (e.g., clinical data 2 or medical data 2) regarding condition of the patient. The data 2 may come from a variety of sources as described above. As a matter of convention, this graphic denotes diverse data 2 by use of subscripts (n, n+1, n+2, . . . ). The data 2 may be aggregated by the DMA 100 into an electronic medical record (EMR) 5. Generally, this process is supervised by the primary care physician through use of appropriate user interface equipment such as a workstation (not shown).

Once the PCP has completed any diagnostic procedures deemed appropriate and the results have been entered into the electronic medical record (EMR) 5, then the PCP may determine that a referral for specialized services is warranted. If the PCP believes a referral is warranted, then the PCP may enter symptoms of the patient that indicate the need against a listing from payer criteria or appropriate use criteria 6. Once the PCP has completed a provider portion of an application (that is, has included relevant symptoms of the patient, added any notes and the like) a preauthorization engine (PE) 10 will draw on the electronic medical record (EMR) 5 for any additional information as appropriate. The preauthorization engine (PE) 10 will then electronically submit a completed application to payer 12 for preauthorization of the referral. The payer 12 will then evaluate the application and either one of approve or deny the application. The request and the approval or denial may be communicated by, for example, EDI protocol.

Generally, in evaluation of each application, each payer 12 will consider medical benefits available to the patient, policies regarding requirements for payer criteria or appropriate use criteria 6 and symptoms that must be exhibited by a patient, nature of the services requested and other such factors. In common embodiments, the payer 12 is one of an insurance company, a health maintenance organization (HMO), an administrator, a government representative, and other such similarly situated enterprise.

Conventional techniques for application for preauthorization have involved physical transfers of medical records to the payer 12. For example, in the prior art, an individual in the office of the PCP would assemble as much information as possible and provide this via, for example, a fax machine to the payer 12. Often, this did not include a good correlation with payer criteria or appropriate use criteria 6 and may have provided incomplete medical records 5.

In contrast, with the DMA 100, providers are able to obtain real-time or near real-time preauthorization of applications for referrals. That is, the DMA 100 may further provide payer 12 with an analysis engine 22. The analysis engine 22 will take into account the variety of considerations that the payer 12 will consider when making a decision on an application. Accordingly, the analysis engine 22 may be configured with rules as well as communication capabilities to access client (i.e., patient) information and the like.

By virtue of the analysis engine 22, as well as other aspects of the DMA 100, preauthorization may proceed in a rapid fashion. The analysis engine 22 may include supervisory capabilities. Supervisory capabilities may be used, for example, to monitor preauthorizations for accuracy, to make discretionary input, to sideline complicated applications, and the like. The analysis engine 22 may generally be placed behind a firewall and/or otherwise inaccessible to parties outside of the enterprise of the payer 12.

Once an application for referral has been evaluated, a decision (i.e., approval or denial of the application) will be provided. The payer 12 will issue the decision to the preauthorization engine 10. Decision information will then be passed by the preauthorization engine 10 with all other relevant patient information. The information passed is generally referred to as “referral information” 15 and is provided to the specialist for patient intake and subsequent specialized diagnoses or therapy. Generally, the referral information 15 may be made available to all interested parties as deemed appropriate, including the patient.

Having provided an overview of the preauthorization process, more detail is now provided. Specifically, FIGS. 13-24 provide exemplary screenshots for a user interface. The screenshots are provided in an order that generally follows the overview provided above.

Note that the embodiments depicted in FIGS. 13-24 may be implemented through a browser or other type of platform independent interface. Accordingly, functionality commonly associated with browsing capabilities is generally provided in these embodiments. For example, pulldown lists, radio buttons, checkboxes, selection buttons, field highlighting, fields darkening, screen highlighting, screen darkening, use of pointers, use of hyperlinks, cut and paste features, click/sort on headers and other such navigational tools or other manipulative tools may be available to users. In short, although exemplary navigational and other manipulative tools are described herein, these examples are merely illustrative and are not limiting of the teachings herein. Additionally, by virtue of connectivity with other systems and/or the various components of the DMA 100, users are provided with access to substantial information. Accordingly, review of these aspects of the DMA 100 is generally limited to that which aids in understanding of the teachings herein but may be implemented in a diverse fashion. Accordingly, these other aspects are likewise merely illustrative and are not limiting of the teachings herein. Further, it should be noted that all patient data provided in the exemplary embodiment is hypothetical data and does not include actual medical records.

Referring now to FIG. 13, an exemplary logon screen 110 is depicted. In this example, the logon screen 110 is provided at a workstation. The logon screen 110 receives user credentials 111 inputs by a user and communicates same with the DMA 100 to log in a user. Generally, conventional security measures for limiting access and enabling user specific configurations are used. As is known in the art, the user will input a user credentials 111 with an accompanying password. Generally, the logon screen 110 may take a user to a content rich introductory screen. However, for purposes of introducing the preauthorization engine 10, additional capabilities of the DMA 100 are generally not discussed in FIGS. 13-23. In some embodiments, when a primary care physician (PCP) logs into the DMA 100, the PCP is taken to a patient database presented in the form of a patient roster.

Referring now to FIG. 14, a portion of an exemplary patient database is shown as a patient roster 120. In this example, the roster 120 provides a list of patients under the care of the PCP. More information on any one of the patients may be accessed by simply clicking upon a record for a respective individual patient. In this exemplary embodiment, and with regard to the remaining screenshots, the individual at the top of the roster 120 is considered for a referral.

Patients that are presented in the roster 120 may be arranged in an order that is according to date of upcoming appointments, alphabetically, by age, by a particular medical classification or the like. In some embodiments, patient records may be color-coded or otherwise complemented with certain display attributes (such as with additional text, in bold, italics, blinking text, shaded backgrounds and by other similar techniques). In short, a variety of techniques may be used to enhance display of the patient roster 120 and to increase content and value of the information presented to the PCP.

It may be noted that in the top right-hand corner of the screen shown in FIG. 14, there are shortcut buttons 115. In this embodiment, one of the shortcut buttons 115 displays a username for an active user (on top of a button that is associated with a user page). By clicking on the username button, the user will be taken to a user roles and preferences screen (not shown). In the user roles and preferences screen, each user is provided with a facility for configuration of their respective account. For example, the user may change system passwords, display attributes and other such configuration settings.

Similarly, a button for invoking a patient page may be provided as a shortcut button 115. By clicking on a button for the patient page 123, the user may return to the patient screen (shown in FIG. 14). Accordingly, a plurality of shortcut buttons 115 (e.g., the user page 122 and the patient page 123) may appear on this page and in a variety of other pages as deemed appropriate. Other pages may be accessed by other shortcut buttons 115. In general, shortcut buttons 115 as described with regard to FIG. 14 may be provided throughout the DMA 100, and used to navigate a user to another screen as indicated. Generally, when a user navigates to another screen and then completes the desired task, the user may then be returned to the prior screen. For example, consider invocation of user roles and preferences page from the screen displaying the patient roster 120. In this example, the user will click the button for the user page 122. The user will then be navigated to a screen for updating user roles and preferences. Once the user has completed updating user roles and preferences, then the user will save the preferences (for example, by clicking on a save button). At this point, the user will be returned to the screen displaying the patient roster 120 (as shown in FIG. 14). Alternatively, the user may be directed to a homepage for the DMA 100 or as otherwise determined appropriate.

In this embodiment, in order to complete an application for referral, the primary care physician (PCP) will select (i.e., click on) a patient record in the patient roster 120. By selecting the patient record, the PCP will access aspects of electronic medical record for a given patient.

Referring now to FIG. 15, a main referral screen 150 is shown. In this example, the main referral screen 150 includes various sections that provide information on the given patient. Personal information may be provided in a personal information section 130 and may include information such as name, address, birthdate, contact information and insurance providers. The main referral screen 150 may include at least one of a referral button 151 and a listing of referral applications in a referral application section 152. The listing in the referral application section 152 may include information such as a referring physician, a referred to physician, and application status and other higher-level information (or any other type of information of particular interest for a given patient).

Similar to the plurality of shortcut buttons 115, a navigation section 116 may be provided. The navigation section 116 may appear in a variety of user screens and webpages within the DMA 100. Generally the navigation section 116 will indicate a level of a user page within the DMA 100. For example, by clicking the left most hyperlink of the navigation section 116, user may be taken to a homepage. By clicking a hyperlink just to the left of the present page, the user may be taken to a parent page. The navigation section 116 may be used to provide context sensitive navigation and other tools as deemed appropriate. For example, an array of hyperlinks provided in the navigation section may be task oriented.

Generally, by clicking upon the referral button 151 (or any other similar switch or navigational tool) the user will be taken from the main referral screen 150 to a referral detail screen. Consider the referral detail screen provided in FIG. 16.

Refer now to FIG. 16 where a referral detail screen 160 is shown. Like the main referral screen 150, the referral detail screen 160 may include the personal information section 130. The referral detail screen 160 may include a basic medical information section 161, the referral personnel section 162, a service request field 163, a supporting medical information 164 section, and an action panel 165 as well as other similar sections deemed appropriate. Generally, the basic medical information section 161 may include most recent data on vital signs such as height, weight, body mass index (BMI), blood pressure, pulse and other such information. Generally, the referral personnel section 162 will identify an ordering physician and a referred to physician. The service request field 163 may broadly identify a type of service requested. The supporting medical information section 164 may include any type of record deemed to support the service request. For example, notes generated by a doctor or other medical professional, historic information, a variety of forms of clinical data including: lab work; imaging data; video and/or audio data and the like may be included in the supporting medical information section 164. The supporting medical information section 164 may be populated with medical record for each patient separately and independent of the main referral screen 150, and the referral detail screen 160. Alternatively, the supporting medical information section 164 may be populated or supplemented with medical record for each patient through at least one of the main referral screen 150 and the referral detail screen 160. Accordingly, a variety of other user interface tools (i.e., buttons, additional webpages, and the like) may complement the supporting medical information section 164. Generally, once a referring physician has completed input of information into the referral detail screen 160, the referring physician will invoke the action panel 165. That is, the referring physician may either select (i.e., click on) “save” or “refer.” In some embodiments, if the referring physician elects to save the referral application, then the referring physician may later return and continue completion of the application. Generally, once the referral application has been completed by the referring physician, then the referring physician will select (i.e., click on) the “refer” button to submit the referral application to the preauthorization engine 10.

The PCP may select an individual to whom the referral is directed. For example, the PCP may wish to select a specialist that is within the practice of the PCP, in the same hospital as the PCP or otherwise associated with the PCP. The PCP may wish to select a specialist according to other attributes such as board certification, a reputation score or other criteria. Accordingly, the DMA 100 may include data tables that assist the PCP with selection of an appropriate specialist. Tables of specialists as may be presented to the PCP may include color coding or other forms of emphasis to assist with selection. Generally, the DMA 100 may present the PCP with selection tools (such as the foregoing) for selection of a specialist.

FIG. 17 depicts an exemplary note that may be included in the supporting medical information. In this example, the referring physician may have simply typed the information into a comments box as shown in the main referral screen (FIG. 15). In some other embodiments, this is information is entered via a chart note. Such as by clicking on a button for entry of the chart note.

Referring now to FIG. 18, a coding button 171 and an appropriate use guidelines button 172 are shown. In some embodiments, the coding button 171 and the appropriate use guidelines button 172 are context sensitive devices. That is, at least one of the coding button 171 and the appropriate use guidelines button 172 may only appear when a specific class of service is requested. In this example, the patient is being referred for a transthoracic echocardiography. Accordingly, it has been predetermined that certain criteria must be present to justify this procedure. Once the user has identified a particular service request in the service request field 163, at least one of the coding button 171 and the appropriate use guidelines button 172 may appear. In some embodiments, the coding button 171 and the appropriate use guidelines button 172 are static features on the referral detail screen 160. That is, for static embodiments, the coding button 171 and appropriate use guidelines button 172 are constantly present. In order to enter appropriate codes (such as, for example, ICD-9 codes, ICD-10 codes or codes associated with another coding scheme), the user will simply press on the coding button 171. Similarly, in order to enter appropriate use guidelines, the user will simply press on the appropriate use guidelines button 172.

Referring now to FIG. 19, an embodiment of the referral detail screen 160 is shown. In this example, the coding button 171 has been selected by the user. In this embodiment, selection of the coding button 171 causes a dark shading over the referral detail screen 160, and a pop-up window to appear. The pop-up window provides a table of codes 180. The table of codes 180 includes codes that are associated with the particular service request. Accordingly, the DMA 100 will filter the codes such that the user is provided with only the relevant codes within the table of codes 180. In practice, the user will simply check or otherwise identify all of the codes that apply to the patient. That is, for example, symptoms exhibited by the patient are identified and associated with a particular code.

Referring now to FIG. 20, another embodiment of the referral detail screen 160 is shown. In this example, the appropriate use guidelines button 172 has been selected by the user. In this embodiment, selection of the appropriate use guidelines button 172 causes a dark shading over the referral detail screen 160 and a pop-up window to appear. The pop-up window provides a table of appropriate use guidelines 190. The table of appropriate use guidelines 190 includes a list of criteria that are associated with a particular service request. Accordingly, the DMA 100 will filter the appropriate use guidelines such that the user is provided with only the relevant appropriate use guidelines within the table of appropriate use guidelines 190. In practice, the user will simply check or otherwise identify all of the appropriate use guidelines that apply to the patient. That is, for example, the user will enter information related to the symptoms prior treatment or plans treatment as appropriate.

Referring back now also to FIG. 12, the payer 12 will generally consider selected codes and selected appropriate use guidelines when making a decision for preauthorization. Consideration of selected codes and selected appropriate use guidelines may be performed electronically, and further factor other aspects deemed appropriate by the payer 12. For example, the payer 12 may have internal policies or procedures that relate to any particular decision.

Referring now to FIGS. 21 and 22, exemplary embodiments of completed referral detail screens 160 are shown. Upon completion of all sections of the referral detail screen 160, the user will select an appropriate action to complete the referral request.

Referring to FIG. 23, the main referral screen 150 is shown is shown. In this example, the referral application just completed is shown in the referral applications section 152.

Referring now to FIG. 24, a referred patient detail screen 220 is shown. In this example, the referred patient detail screen 220 is available to the specialist. Generally, the referred patient detail screen 220 provides personal and medical information that was included in the application by the primary care physician. For example, the referred patient detail screen 220 includes the personal information section 130, the basic medical information section 161, the referral personnel information section 162, the service request field 163, and this supporting medical information section 164. Additionally, the referred patient detail screen 220 provides a specialist with an application status section 231. The application status section 231 provides the decision of the payer 12 and any additional referral information 15. In some embodiments, the referred patient detail screen 220 permits the specialist to supplement the supporting medical information, as well as to supply notes in the specialist notes section.

Having thus introduced embodiments of the DMA 100 for performing patient referral, it should be understood that a variety of additional aspects may be included or related to the patient referral process. For example, a variety of queries and reports may be included in the DMA 100. While querying and reporting tools may draw on patient referral information, the information derived from such tools may provide insight into clinical information as well as financial aspects of healthcare. For example, trends in patient conditions, diagnoses, therapy and the like may be easily identified.

Further, a variety of advantages are realized through the DMA. For example, with regards to providers, a single point of entry into all payers instead of accessing individual payer sites enables simple access. Real-time two-way electronic sharing of patient information provides for expedient determinations. Higher quality prior-authorization submissions based on specific payer guidelines results in system efficiency, and greater certainty. Reduction in operational costs by increasing physician workflow and staff efficiency is realized. Faster turn-around to prior authorization is achieved, lowering overhead costs.

Further, with regards to payers, receipt of higher quality prior authorization requests based on payer's own medical necessity guidelines simplifies processing. Elimination of the paper-chase process currently used reduces mistakes and costs while improving throughput. A digital log file is available and provides for tracking, status, and follow-up either locally and/or remotely. Further, the system provides for reduction of requests requiring peer-review consultations, as well as faster turn-around response to prior authorization submissions, thus lowering overhead costs.

In a first aspect, embodiments provide the capability for integrating all patient information that is stored on one or more disparate data sources (electronic medical record systems, imaging systems, lab information systems, office notes systems, imaging systems, etc.) based on physicians role and patients clinical status.

In a second aspect, embodiments provide a method for the customizing all the relevant clinical information needed by the physician (blood, labs, office notes, prior reports, images, etc.) based on individual physician needs, group needs, departmental or specialty needs and organizational needs.

In a third aspect, embodiments provide a method for combining one or more of standard of care, payer criteria and appropriate use criteria with role based customization and the knowledge of the patient's clinical information.

In a fourth aspect, embodiments provide a method to display the relevant clinical information via a “smart dashboard” enterprise-wide in an easy to understand color-coded fashion on any device, anywhere in a public or private cloud with images launched in the user's viewer of choice.

In a fifth aspect, embodiments provide a method for performing various analysis (Natural language processing, algorithmic processing, etc.) on the available (prior and current) patient data to organize the clinical information based on the preferences of the physician(s), to drive a more informed workflow and efficient user experience.

In a sixth aspect, embodiments provide a method for delivering the information via enterprise or cloud based servers to client systems with zero or minimal footprint on the client side, running on any web browser or displayed on any computer, tablet, smartphone, or mobile device.

In a seventh aspect, embodiments provide a method for securely uploading, storing and retrieving the patient information to and from a server.

In an eight aspect, embodiments provide a method for either automatically or semi-automatically determining the relevant clinical context to be presented to the physician based on the physician's role/specialty and patient being looked at.

It should be recognized that the teachings herein are merely illustrative and are not limiting of the invention. For example, although the term “primary care physician (PCP)” and specialist are generally referred to herein to describe the referral process, referral is not limited to being conducted between a PCP and a specialist. For example, any other professional (i.e., user) may refer an individual to another professional (i.e., user). More specifically, and by way of example, a nurse or physician's assistant may order specialized services such as additional lab work through use of the DMA 100. While the DMA 100 is presented and discussed in terms of a medical setting, use of the DMA 100 is not limited to the medical profession. That is, the DMA 100 may be used in any environment where it is deemed to be suitable.

As discussed herein, the terms “automatic,” “real-time” and other similar terms are to be evaluated according to the standards of the user or other interested party. Generally, the term “automatic” implies limited to substantially no human interaction. Generally, the term “real-time” implies performance of a task in a rate that is suited for a continuation of the task relatively unperturbed. For example, “real-time” preauthorization may simply refer to preauthorization that occurs while a patient remains in a doctor's office or is traveling to see a specialist. A “near real-time” basis may generally be considered to involve a period of time the results in a minimal or limited impact on continuation of the task.

The nature of the DMA 100 is such that it may share characteristics with “enterprise systems” which may include “middleware.” That is, the DMA 100 may include many aspects of large-scale information technology resources. For example, the DMA 100 may include substantial databases that include a variety of billing codes, appropriate use guidelines, and other medical information. The DMA 100 may be provided with a substantial number of application programming interfaces (APIs) such that the DMA 100 may be configured for communications with other resources. The DMA 100 may be provided with interfaces and/or communications with a plurality of third-party payers 12. Interfaces in communications with third-party payers 12 may be adapted according to the needs of each of the third-party payer 12. The DMA 100 may include internal management resources. The internal management resources may, for example, check for and update information needed for proper operation of the DMA 100.

While the DMA 100 is generally referred to herein as a “digital medical assistant,” this terminology is not intended to be limiting of the DMA 100. Rather, the DMA 100 should be considered in light of the disclosure provided herein and the appended claims.

Further, one skilled in the art will recognize that additional components, configurations, arrangements and the like may be realized while remaining within the scope of this invention. For example, communications with equipment, third parties, users and others and the like may be varied from embodiments disclosed herein. Generally, design and/or application of components of the digital medical assistant is limited only by the needs of a system designer, manufacturer, operator and/or user and demands presented in any particular situation.

It should be recognized that the system herein provides for preauthorization, however the system may be used equally well for authorization of a service request after services have been provided. That is, the term “preauthorization” is merely illustrative and is not limiting of the teachings herein.

It should be recognized that “preauthorization criteria” as used herein generally includes at least one of a standard of care, an expert opinion, availability of technology, payer criteria, appropriate use guidelines, and evidence based criteria.

As discussed herein, a “service request” may include any type of request deemed medically necessary to serve the needs of a patient. For example, and without limitation, the service request may include a request for: a referral, a lab test, a procedure, pharmaceutical products and services, admission to an institution, and extension of ongoing products or services being delivered to the patient. The service request may be applicable for any type of service considered appropriate, such as general medical, specialized medical, dental, vision and other types of services.

Various other components may be included and called upon for providing for aspects of the teachings herein. For example, additional systems and resources, combinations of systems and resources and/or omission of systems and resources may be used to provide for added embodiments that are within the scope of the teachings herein.

When introducing elements of the present invention or the embodiment(s) thereof, the articles “a,” “an,” and “the” are intended to mean that there are one or more of the elements. Similarly, the adjective “another,” when used to introduce an element, is intended to mean one or more elements. The terms “including” and “having” are intended to be inclusive such that there may be additional elements other than the listed elements.

In the present application a variety of variables are described, including but not limited to interfaces, resources, and communications characteristics. It is to be understood that any combination of any of these variables can define an embodiment of the invention. Other combinations of articles, components, conditions, and/or methods can also be specifically selected from among variables listed herein to define other embodiments, as would be apparent to those of ordinary skill in the art.

While the invention has been described with reference to exemplary embodiments, it will be understood by those skilled in the art that various changes may be made and equivalents may be substituted for elements thereof without departing from the scope of the invention. In addition, many modifications will be appreciated by those skilled in the art to adapt a particular instrument, situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A digital medical assistant configured to obtain authorization of a service request, the assistant comprising:
an input for receiving an electronic medical record (EMR) of a patient and identity of a benefit provider for the patient;
a preauthorization engine configured for completing an application by identifying relevant clinical context from the EMR and correlating the relevant clinical context with preauthorization criteria;
the preauthorization engine further configured for submitting a completed application as the request to the benefit provider, receiving a decision from the provider, and outputting the decision.

2. The digital medical assistant as in claim 1, wherein the electronic medical record (EMR) comprises information from at least one of diagnostic equipment, therapeutic equipment, a patient database, a computer network, a remote system, and input from a medical professional.

3. The digital medical assistant as in claim 1, wherein the criteria comprise at least one of a payer criteria and an appropriate use guideline.

4. The digital medical assistant as in claim 3, wherein the payer criteria comprise at least one of a rule, a guideline, and a policy of the benefit provider.

5. The digital medical assistant as in claim 3, wherein payer criteria consider at least one of a standard of care, an expert opinion, the availability of technology, and evidence-based criteria.

6. The digital medical assistant as in claim 3, wherein the appropriate use guideline comprise at least one of a pathway table, a quality measure, and a form of integrated medical evidence.

7. The digital medical assistant as in claim 3, wherein the appropriate use guideline comprise at least one of a standard of practice, an expert opinion, the availability of technology, and evidence-based criteria.

8. The digital medical assistant as in claim 1, further comprising another input for initiating the application.

9. The digital medical assistant as in claim 8, wherein the another input comprises at least one of input from a user interface, a patient condition, as a result of analysis of patient data.

10. A method for obtaining authorization for a service request for a patient, the method comprising:
electronically initiating the service request by selecting a procedure;
identifying relevant clinical context from an electronic medical record (EMR) of the patient and correlating the relevant clinical context with preauthorization criteria;
submitting a completed application as the request to the benefit provider, receiving a decision from the provider, and outputting the decision.

11. The method as in claim 10, wherein choices for the relevant clinical context are presented according to at least one of the procedure selected and a role of a user.

12. The method as in claim 10, wherein identifying relevant clinical context comprises classifying a patient diagnosis according to a classification scheme.

13. The method as in claim 10, wherein the classification scheme comprises a plurality of classification codes.

14. The method as in claim 10, wherein the preauthorization criteria comprise at least one of payer criteria and an appropriate use guideline.

15. The method as in claim 10, further comprising electronically requesting at least a portion of the electronic medical record (EMR).

16. The method as in claim 11, wherein authorization is performed on one of a real-time basis and a near real-time basis.

17. A computer program product stored on machine readable media, the product comprising instructions for implementing a method for obtaining authorization for fulfillment of a service request, by:
electronically initiating the service request by selecting a procedure;
identifying relevant clinical context from an electronic medical record (EMR) of the patient and correlating the relevant clinical context with preauthorization criteria;
submitting a completed application as the request to the benefit provider, receiving a decision from the provider, and outputting the decision.

18. The computer program product as in claim 17, further comprising instructions for associating selected classification codes and appropriate use guidelines with the service request.

19. The computer program product as in claim 17, further comprising at least one interface for electronically receiving information from an external database, a computer network, a remote system, a user interface, and clinical equipment.

20. The computer program product as in claim 17, further comprising instructions for configuring a user interface according to defined roles and preferences.
